(19) United States
(12) Patent Application Publication
(10) Pub. No.: US 2008/0114910 A1
(43) Pub. Date: May 15, 2008

(54) APPARATUS AND METHOD FOR HIGH SPEED ULTRASONIC DATA ACQUISITION

(75) Inventors: Xujin HE, Shenzhen (CN); Zhe WANG, Shenzhen (CN); Man YUAN, Shenzhen (CN)

Correspondence Address: WORKMAN NYDEGGER, 60 EAST SOUTH TEMPLE, 1000 EAGLE GATE TOWER, SALT LAKE CITY, UT, 84111, US

(73) Assignee: SHENZHEN MINDRAY BIO-MEDICAL ELECTRONICS CO., LTD, Shenzhen (CN)

(21) Appl. No.: 11/858,758

(22) Filed: Sep. 20, 2007

(30) Foreign Application Priority Data
Nov. 15, 2006 (CN) 200610156945.8

(51) Int. Cl. G06F 13/28; G06F 13/00

(52) U.S. Cl. 710/52; 710/22

(57) ABSTRACT

The present invention provides an apparatus and method for high-speed ultrasonic data acquisition. The apparatus is arranged within an ultrasonic detection system, and comprises: an acquisition interface, coupled to the ultrasonic detection system, for obtaining ultrasonic data from the ultrasonic detection system; a large-capacity buffer for holding the ultrasonic data obtained by the acquisition interface; a high-speed USB (Universal Serial Bus) controller, for transferring the ultrasonic data in the large-capacity buffer to the host computer via a USB interface.

### FIELD OF INVENTION

The present invention relates to an Ultrasonic Diagnostic System and the method thereof, especially to an apparatus and method for ultrasonic data acquisition, with which ultrasonic data from an Ultrasonic Diagnostic System can be transferred to a Host computer in high speed.

### BACKGROUND OF THE INVENTION

Recently, ultrasonic systems have gained popularity for medical diagnosis because they are capable of providing accurate and real time imaging of organs, tissues or blood flow of the body in a non-invasive manner. The ultrasonic system used for medical diagnosis is referred to as ”Ultrasonic Diagnostic System”.

FIG. 1 is a block diagram illustrating a structure of a conventional Ultrasonic Diagnostic System. As shown in FIG. 1, the Ultrasonic Diagnostic System 100 comprises an ultrasonic transducer 110 and a transducer controller 120, both of which are controlled by a CPU 140. The ultrasonic transducer 110 transmits pulses to generate ultrasound waves directed to a target to be scanned, and then receives the echoes reflected by the scanned target. The transducer controller 120 is in charge of controlling the frequency, duration and the scanning mode of the pulses transmitted by the ultrasonic transducer 110. Further, as shown in this figure, under the control of the CPU 140, a data processing unit 150 in the system 100 may process the received echoes, such as performing A/D conversion on them, to generate ultrasonic data, which can be subsequently presented on a display 130 to show the profile of the scanned target. In general, the Ultrasonic Diagnostic System also comprises a memory for storing the ultrasonic data, and an input/output device, such as a keyboard, a mouse and a printer, for the purpose of inputting instructions and outputting the display results.

The Ultrasonic Diagnostic System of FIG. 1 commonly obtains a large number of ultrasonic data for the scanned target in a high speed, the ultrasonic data typically having up to a clock frequency of 40 MHz and a width of 32 bit. In general, however, the Ultrasonic Diagnostic System itself has limited capability in data processing, especially in data processing speed. Thus, it is hard to further analyze and process the high-speed ultrasonic data within the Ultrasonic Diagnostic System per se. To this end, a data acquisition card, e.g., a PCI (Peripheral Component Interconnect) data acquisition card, is provided to transfer the high-speed ultrasonic data as described above from an Ultrasonic Diagnostic System to a host computer for more complicated data analysis, while keeping the Ultrasonic Diagnostic System in normal operation.

FIG. 2 is a schematic diagram of a conventional PCI data acquisition card. In the PCI data acquisition card 200, as shown in FIG. 2, the ultrasonic data from the Ultrasonic Diagnostic System 100 is first acquired and held in a buffer 220. Then, under the manipulation of the control logic 280, the ultrasonic data held in the buffer 220 are transferred to a host computer 300 via a PCI bridge chip 250, wherein the control logic 280 controls the transfer timing and ensures the data integrity. Obviously, in the prior art, it is via PCI that the high-speed ultrasonic data is transferred from the data acquisition card of FIG. 2 to the host computer 300.

In the prior art, the PCI data acquisition card of FIG. 2 is usually configured to be plugged in the PCI slot of the host computer, thereby being arranged inside the host computer. Due to this, line connections have to be established between the PCI data acquisition card 200 and the Ultrasonic Diagnostic System 100, typically a flat cable having multiple lines is used therebetween. However, it has been noted that the flat cable is not adaptable to the transfer of high-speed signals, because the interference between the adjacent lines has significant impact on the signal quality, which further causes the Ultrasonic Diagnostic System to be off-normal. Furthermore, once the flat cable is used, a large number of lines are connected to the inside of the Ultrasonic Diagnostic System. Thus, the casing of the Ultrasonic Diagnostic System is normally unclosed, and thereby it might have a negative effect on the normal operation of the system.

Additionally, PCI data acquisition card is required to be plugged into the inside of the host computer, which is very inconvenient and goes against the mobile data acquisition. Further, the buffer 220 in PCI data acquisition card 200 usually has a limited buffering capacity. For this reason, when the high-speed ultrasonic data has a bandwidth greater than that of PCI bus, part of the ultrasonic data are very likely to be lost, and thus real time imaging would be interrupted.

Due to the above defects of the PCI data acquisition card in the art, there is a need to provide a new apparatus and method for data acquisition, which is capable of acquiring the high-speed ultrasonic data.

### SUMMARY OF THE INVENTION

An object of present invention is to provide an apparatus and method for ultrasonic data acquisition. With the provided apparatus and method, high-speed ultrasonic data can be transferred from an Ultrasonic Diagnostic System to a host computer in real time or non-real time, without bringing any impact on the normal operation of the Ultrasonic Diagnostic System due to too many lines.

To achieve the object as mentioned above, it is provided an apparatus for ultrasonic data acquisition, which is directly plugged into the inside of the Ultrasonic Diagnostic System and connected to a host computer via a USB (Universal Serial Bus) interface. The apparatus for ultrasonic data acquisition according to the present invention comprises:

an acquisition interface, coupled to the Ultrasonic Diagnostic System, for obtaining ultrasonic data from the Ultrasonic Diagnostic System;

a large-capacity buffer, for holding the ultrasonic data obtained from the acquisition interface;

a high-speed USB controller, for transferring the ultrasonic data held in the large-capacity buffer to the host computer via a USB interface.

In present invention, since the high-speed USB interface is provided between the host computer and the Ultrasonic Diagnostic System provided with the data acquisition apparatus as above, the transfer of high-speed data can be achieved without lowering the quality of the ultrasonic data.

Moreover, the large-capacity buffer in the ultrasonic data acquisition apparatus may be a DDR (Double Data Rate DRAM) buffer, which is capable of providing sufficient memory space to hold a large amount of ultrasonic data.

Furthermore, the ultrasonic data acquisition apparatus according to present invention may further comprise one of a DMA (Direct Memory Access) channel unit, a DDR controller and an embedded processor. One or more of the acquisition interface coupled to the Ultrasonic Diagnostic System, the DDR controller for controlling the DDR buffer, the DMA channel unit and the embedded processor may be based on a FPGA (Field Programmable Gate Array). Thus, the ultrasonic data acquisition apparatus of present invention may be flexibly configured as desired.

To achieve the object as mentioned above, it is also provided a method for ultrasonic data acquisition performed by the ultrasonic data acquisition apparatus as described above.

### BRIEF INTRODUCTION OF THE DRAWINGS

The appended claims are directed to some of the various embodiments of the present invention. However, the detailed description presents a more complete understanding of embodiments of the present invention when considered in connection with the figures, wherein like reference numbers refer to similar items throughout the figures and:

FIG. 1 is a block diagram illustrating a structure of a conventional Ultrasonic Diagnostic System;

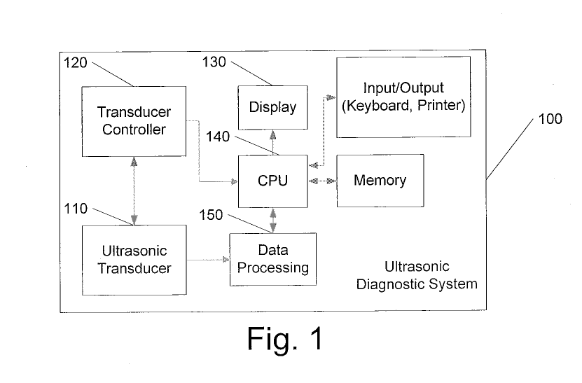

FIG. 2 is a block diagram of a conventional PCI data acquisition card;

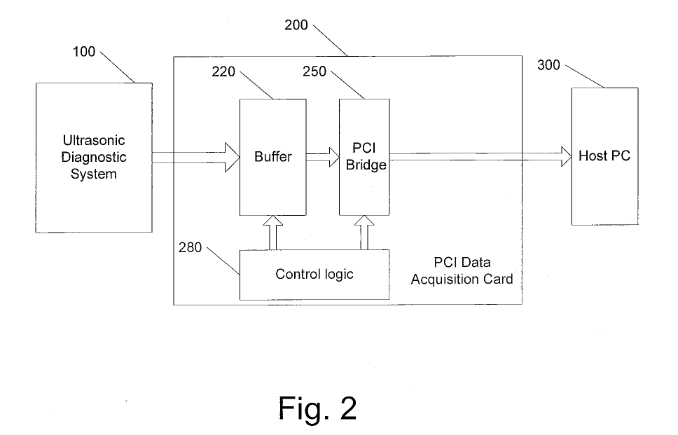

FIG. 3 is a block diagram of an ultrasonic data acquisition module according to an embodiment of present invention;

FIG. 4 is a schematic diagram for illustrating the connection between the Ultrasonic Diagnostic System and the ultrasonic data acquisition module according to an embodiment of present invention;

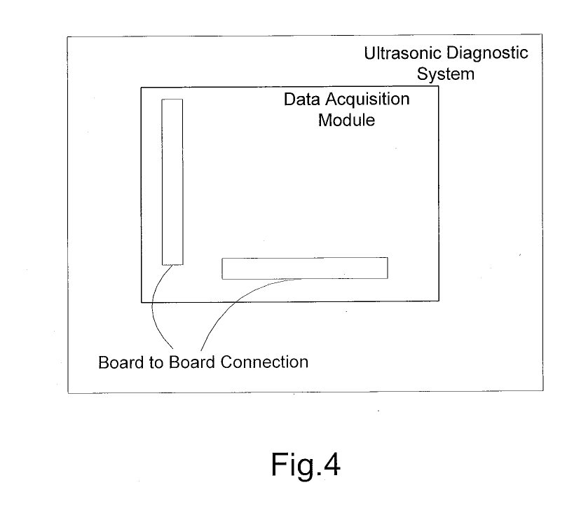

FIG. 5 is a flow chart illustrating the operation of the ultrasonic data acquisition module according to an embodiment of present invention;

FIGS. 6 and 7 are schematic diagrams of the buffer configurations when the real time transfer of ultrasonic data is performed in the unit of scanning line or in the unit of frame, respectively.

### DETAILED DESCRIPTION OF THE INVENTION

In the following, various preferred embodiments will be described in detail in connection with the appended drawings.

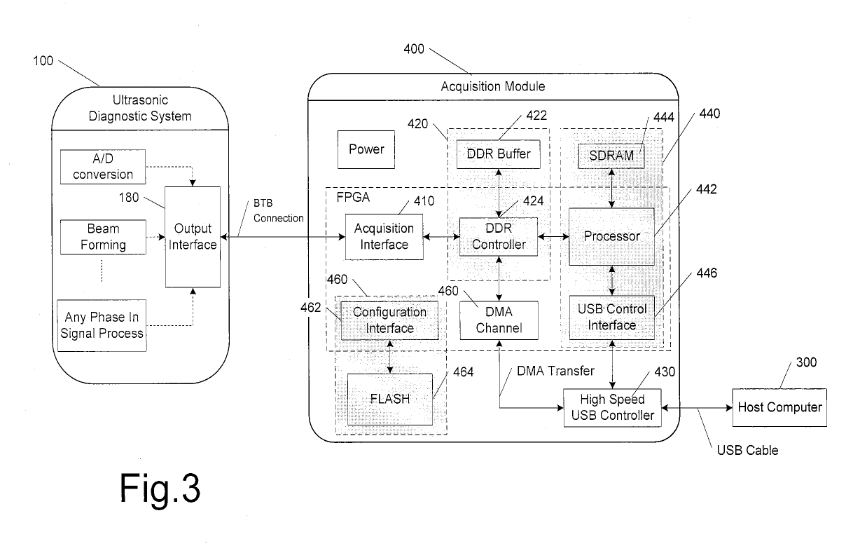

FIG. 3 shows an ultrasonic data acquisition module 400 according to an embodiment of present invention, which is connected between a conventional Ultrasonic Diagnostic System 100 and a host computer 300.

In FIG. 3, the conventional Ultrasonic Diagnostic System 100 comprises an A/D conversion circuit, a beam forming circuit, other optional signal processing circuits, and an output interface 180 coupled to ultrasonic data acquisition module 400 of present invention (hereinafter referred to as “acquisition module 400” for short). As shown in FIG. 3, the acquisition module 400, on the one hand, is provided within the Ultrasonic Diagnostic System 100, preferably plugged into a preset socket or slot on the main board of the Ultrasonic Diagnostic System 100. On the other hand, the acquisition module 400 is coupled to the host computer 300 via a USB interface, that is, the data is transferred via a USB cable.

The acquisition module 400 may be provided within the Ultrasonic Diagnostic System 100 in various manners. Preferably, the acquisition module 400 is arranged in the Ultrasonic Diagnostic System 100 by using a Board-to-Board (BTB) connection. In specific, the Ultrasonic Diagnostic System 100 has a preset female interface (socket) arranged on the main board thereof, while a mating male interface (pin) is arranged on the acquisition module 400. By mating the male and female interfaces, the acquisition module 400 can be arranged on and electrically connected to the main board within the casing of the Ultrasonic Diagnostic System 100. Such a BTB connection is especially adaptable to the transfer of high-speed data. Also, in this manner, the acquisition module 400 of FIG. 3 may be designed independent to the Ultrasonic Diagnostic System. This prevents the acquisition module from affecting the normal operation of the Ultrasonic Diagnostic System, and further makes it easy to plug in the acquisition module 400.

Furthermore, the acquisition module is easy to be connected and can provide a transfer with superior signal performance, since it only uses a USB interface as an output to the host computer. Thus, the acquisition module of present invention is capable of transferring the high-speed ultrasonic data with desirable signal quality.

Referring back to FIG. 3, the acquisition module 400 of present invention specifically comprises: a power supply, an acquisition interface 410 matching with the output interface 180 of the Ultrasonic Diagnostic System, a large-capacity buffer 420, a high-speed USB controller 430, and a control unit 440.

In theory, the large-capacity unit 420 may be any of the suitable memories in the art based on specific applications. In the present embodiment, the unit 420 is preferably comprised of a DDR (Double Data Rate DRAM) buffer 422 and a DDR controller for controlling access to the DDR buffer. In this case, as shown in FIG. 3, under the control of the control unit 440, the acquisition interface 410 may obtain the ultrasonic data of echoes from the Ultrasonic Diagnostic System 100, and hold the obtained data in a line buffer such as a FIFO (First In First Out) thereof. Subsequently, according to the command from the control unit 440, the DDR controller 424 reads out the ultrasonic data held in the FIFO and write the read data into the DDR buffer 422 immediately. This procedure will not end until all of the ultrasonic data are completely acquired and held in the DDR buffer as specified. After the acquisition is finished, also under the control of the control unit 440, DDR controller 424 reads out the ultrasonic data held in the DDR buffer 422 and transfers them to the high speed USB controller 430, so that the read out ultrasonic data may be transferred to the host computer 300 via the USB interface.

In order to increase the transfer speed, in the present embodiment, a DMA (Direct Memory Access) channel is established between the large-capacity buffer 420 and the high speed USB controller 430, that is, a DMA channel unit 450 is added therebetween, as shown in FIG. 3. DAM transfer mode is characterized in that the DMA channel unit may separately implement the high-speed data transfer without any intervention from a control unit or a CPU. For this reason, the DMA channel can speed up the data transfer rate greatly. In addition, for a much higher speed, the high speed USB controller 430 is implemented according to the protocol of USB 2.0, which can achieve a transfer rate of 480 Mb/s in theory.

Also, in FIG. 3, the control unit 440 specifically includes an embedded processor 442, a program storage 444 and a USB control interface 446. The program storage 444 provides the program space for the processor 442, and may be, for example, a ROM configured with a preset system program, or a SDRAM loaded with the system program after power on. The USB control interface 446 is connected between the processor 442 and the high speed USB controller 430, and configured to receive commands from the host computer 300 and send the status information thereto via the high speed USB controller 430.

Please be noted that one or more of the units shown in FIG. 3, i.e., any one of the acquisition interface 410, DDR controller 424, processor 442, USB control interface 446 and DMA channel unit 450 may be based on FPGA. These functional units as listed above, when being based on FPGA, may be flexibly configured or modified as desired, which enhances the applicability of the acquisition module 400. For example, if the acquisition interface 410 is based on FPGA, it can be modified according to the various configurations of the output interfaces in Ultrasonic Diagnostic Systems 100, and thus it can be applied to most kinds of Ultrasonic Diagnostic Systems.

In the present embodiment, the functional units as mentioned above are all based on FPGA. Due to this, a configuration unit 460 is provided therein, as shown in FIG. 3. The configuration unit 460 includes a FPGA configuration interface 462 for configuring the FPGA, and a non-volatile memory, such as a FLASH 464, for storing the configuration file of FPGA and the system software to be executed by the processor 442. Once power on, the FPGA configuration interface 462 first configures the FPGA based on the configuration file in FLASH 464, and loads the system software in FLASH to the program storage (SDRAM) 444 at the same time, so as to get ready for executing the system software. Here, FLASH 464 can be used to update the system software, since it is erasable.

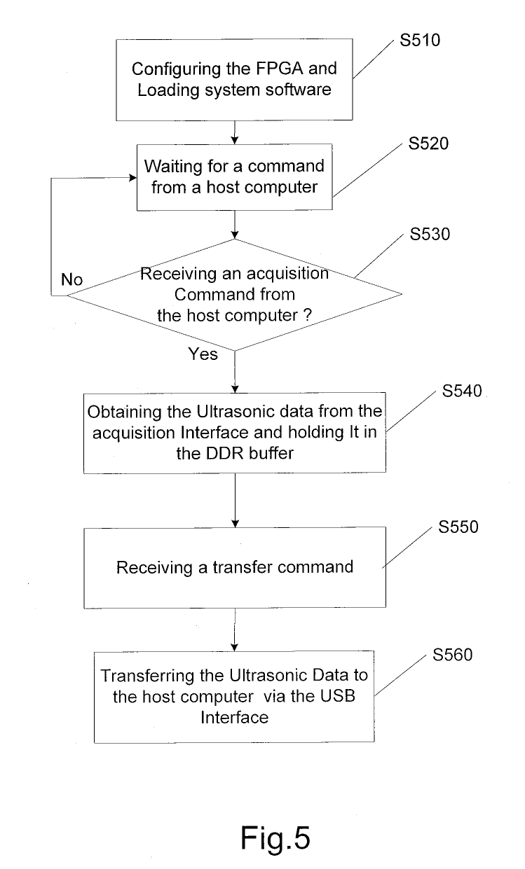

FIG. 5 shows a flow chart of the system software executed by the acquisition module 400, i.e. a flow chart for acquisition and transfer of the ultrasonic data. According to the embodiment of present invention, the acquisition and transfer herein may be performed in real time or non-real time. FIG. 5 shows the one in non-real time.

As shown in FIG. 5, in step S510, the configuration file of FPGA and the system software are first loaded as described above, then the processor 442 runs the system software and enters into the normal operation status. During the normal operation, the processor waits for an acquisition command (step S520), and periodically detects whether the acquisition command is received from the host computer via the USB interface (step S530). If the acquisition command is received together with the information about the desired data length, the procedure of FIG. 5 proceeds to step S540. Otherwise, the processor keeps on waiting.

In step S540, the processor 442 controls the acquisition interface 410 to start obtaining the ultrasonic data from the Ultrasonic Diagnostic System 100, and configures the DDR controller 424 to write the ultrasonic data obtained by the acquisition interface 410 into the DDR buffer 422. When all of the ultrasonic data are held in the DDR buffer as indicated in the desired data length, an indication bit of data acquisition is set, which indicates the status of data acquisition. During the acquisition, the host computer 300 may poll the acquisition module, i.e., causing the processor 442 to report the acquisition status, or the above indication bit. Upon checking a set indication bit, the host computer sends a transfer command to the acquisition module 400, which instructs the module to transfer the ultrasonic data to the host computer (step S550).

After receiving the transfer command, the processor 442 instructs the DDR controller to read out the ultrasonic data from the DDR buffer 422, and transfers the ultrasonic data to the host computer 300 via the DAM channel unit 450 and the high-speed USB controller 430 (step S560). At last, the host computer 300 performs the subsequent analysis or processing on the ultrasonic data, which are received from the acquisition module 400 via the USB interface, for further diagnostic information.

In addition to the non-real time manner as shown in FIG. 5, the acquisition module 400 of present invention may also provide the ultrasonic data to the host computer 300 in real time. For the real time transfer, the acquisition interface 410 of FIG. 3 may be configured to further perform a primary processing, such as filtering and/or frame forming, on the obtained ultrasonic data, by modifying the control logic of FPGA. In this way, the processed ultrasonic data may be held in the DDR buffer in the unit of scanning line/frame, and then the ultrasonic data may be easily transferred to the host computer in real time, for further analysis and display. Thus, an Ultrasonic Diagnostic System based on a host computer can be achieved with high speed.

Specifically, the primary processing on the ultrasonic data as mentioned herein includes filtering and/or frame forming, but not limited to this. Filtering the ultrasonic data or like is to decrease the amount of data to be transferred, or lower the data rate. This is very helpful to achieve real time acquisition and transfer, i.e., transferring data at the same time of acquisition.

As known in the art, the ultrasonic data is detected in the unit of scanning line. The continuous data for the same scanning line may be grouped together to form a set of line data, which is temporally spaced from the set for an adjacent scanning line. A predetermined number of sequential sets of line data form a set of frame data, which may be further processed to form a frame of ultrasonic image. Usually, the real time acquisition and transfer may be in the unit of line or frame as mentioned above. If it is desired to be in the unit of frame, the frame forming processing is required.

In order to transfer data at the same time of acquisition, the size of the buffer for holding the ultrasonic data is required to be designed as twice of a single set of line/frame data, i.e. double line/frame buffers are required in addition to the filtering. In this way, while the obtained ultrasonic data is being written into one of the double line/frame buffers, the data in the other filled buffer is being transferred to the host computer, so that the acquisition and transfer may be implemented in real time.

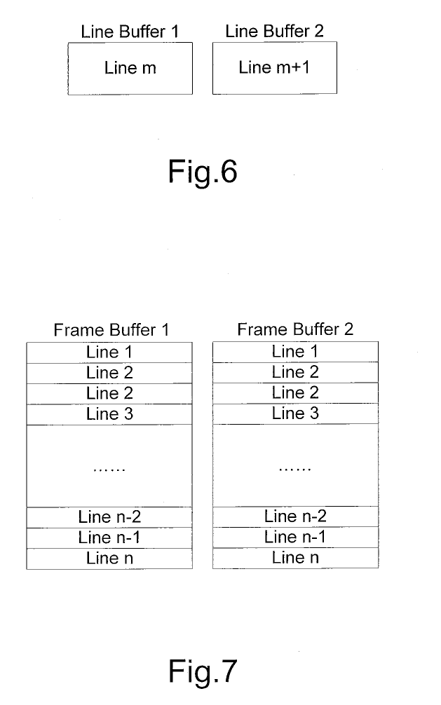

FIGS. 6 and 7 show the configuration of the buffers when the real time acquisition and transfer is achieved in the unit of scanning line or frame, respectively. As shown in FIG. 6, the size of DDR buffer is configured to be double line buffers, i.e., Line Buffer 1 and Line Buffer 2. When the Line Buffer 1 is filled with the obtained ultrasonic data, the processor initiates the real time transfer, that is, transfers the data in the Line Buffer 1 to the host computer, and simultaneously starts to obtain and hold the ultrasonic data for the next scanning line in Line Buffer 2. Once the Line Buffer 2 is filled up, the processor initiates the data transfer for Line Buffer 2, and starts to obtain and hold the ultrasonic data for the further next scanning line in Line Buffer 1. By switching the use of the two buffers, after n times of switches, if one frame comprises n lines, the host computer may receive and display a single completed ultrasonic image. Similarly, for the acquisition and transfer in the unit of a frame, as shown in FIG. 7, the DDR buffer is configured to be double frame buffers, i.e., Frame Buffer 1 and Frame Buffer 2, each of which contains n sets of line data. The two frame buffers may be used in the same way as shown in FIG. 6, that is, acquiring and transferring the data alternatively. FIG. 7 differs from FIG. 6 in that the data transfer cannot be initiated until all of the sets of line data contained in a single frame buffer are filled up, and the host computer can receive and display a frame of ultrasonic image after every transfer.

As discussed above, the real time data acquisition and transfer may be achieved by using two buffers to alternatively acquire and transfer the ultrasonic data. Such a real time manner is especially adaptable to mobile color Ultrasonic Diagnostic system.

### Benefits and Advantages

The apparatus and method for ultrasonic data acquisition has been described in detail according to the preferred embodiments of present invention.

In one aspect, the acquisition module of present invention is arranged within the Ultrasonic Diagnostic System, which allows of obtaining the ultrasonic data from the Ultrasonic Diagnostic System in high speed.

In another aspect, the acquisition module of present invention provides the ultrasonic data to the host computer via a USB interface, thus the transfer may be also performed in high speed without bringing any impact on the normal operation of the Ultrasonic Diagnostic System. It is demonstrated in experiments that the acquisition module of present invention may achieve a rate of 25 MB/s for real time data acquisition.

Also, the flat cable having a number of lines is replaced with a USB cable. Thus, the casing of the Ultrasonic Diagnostic System can be closed, which ensures the system to operate in normal.

Moreover, the acquisition module of present invention uses a DDR buffer as a large-capacity buffer, which is capable of holding sufficient ultrasonic data to be transferred to the host computer. Thus, the obtained ultrasonic data will not be lost due to lower transfer rate. Further, a DMA channel is established in present invention, which further increases the rate for transferring the ultrasonic data from the DDR buffer to the high speed USB controller.

Furthermore, in the acquisition module of present invention, the acquisition interface 410 may be based on FPGA. Thus, the interface circuit and/or interface signals for connection the acquisition module and the Ultrasonic Diagnostic System may be flexibly defined. For example, the acquisition interface 410 may be defined to directly acquire the data after A/D conversion or after any phase in data processing. Also, any of the DDR controller, the DMA channel unit and the embedded process may be based on FPGA, which enhances the flexibility and applicability of the acquisition module as a whole.

It would be apparent that the acquisition module of present invention maybe applied to any other Ultrasonic Detection System having high-speed ultrasonic data, such as Ultrasonic Smart Flaw Detection System, although it is described by taking the Ultrasonic Diagnostic System as an example.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. An apparatus for high-speed ultrasonic data acquisition, which is arranged within a casing of an ultrasonic detection system and used for transferring ultrasonic data from the ultrasonic detection system to a host computer for further processing, the apparatus comprising:
an acquisition interface, coupled to the ultrasonic detection system, for obtaining ultrasonic data from the ultrasonic detection system;
a large-capacity buffer for holding the ultrasonic data obtained by the acquisition interface;
a high-speed USB (Universal Serial Bus) controller, for transferring the ultrasonic data in the large-capacity buffer to the host computer via a USB interface.

2. The apparatus of claim 1, wherein the high-speed USB controller is based on a protocol of USB 2.0.

3. The apparatus of claim 1, wherein the acquisition interface is coupled to the ultrasonic detection system by a board-to-board connection.

4. The apparatus of claim 3, wherein the acquisition interface is based on FPGA (Field Programmable Gate Array).

5. The apparatus of claim 1, wherein the large-capacity buffer is a DDR (Double Data Rate DRAM) buffer, and the apparatus further comprises:
a DDR controller coupled to the acquisition interface, the DDR buffer and the high speed USB controller, for controlling access to the DDR buffer.

6. The apparatus of claim 5, further comprising a DMA (Direct Memory Access) channel unit, coupled between the DDR controller and the high-speed USB controller, for transferring the ultrasonic data in a DMA mode.

7. The apparatus of claim 6, wherein the DMA channel unit and/or the DDR controller is based on FPGA.

8. The apparatus of claim 5, further comprising a processor, coupled to the DDR controller and the high-speed USB controller, for controlling the transfer of the ultrasonic data based on a command, which is received from the host computer via the USB interface.

9. The apparatus of claim 8, wherein the processor is based on FPGA.

10. The apparatus of claim 8, further comprising a FLASH, for storing software to be executed by the processor, for software updating.

11. The apparatus of claim 8, further comprising a USB control interface based on FPGA, for sending status information from the processor to the host computer via the high-speed USB controller or forwarding a command received from the host computer via the high-speed USB controller to the processor.

12. The apparatus of claim 1, wherein the large-capacity buffer comprises two buffers used alternatively, and
one of the two buffers starts to receive and hold the ultrasonic data obtained from the acquisition interface, while the other buffer is filled up and starts transferring the ultrasonic data therein.

13. A method for high-speed ultrasonic data acquisition, comprising the steps of
obtaining ultrasonic data from an ultrasonic detection system via an acquisition interface, which is arranged within and electronically coupled to the ultrasonic detection system;
holding the obtained ultrasonic data;
transferring the held ultrasonic data to a host computer via a USB interface.

14. The method of claim 13, wherein the USB interface is based on a protocol of USB 2.0.

15. The method of claim 13, wherein the acquisition interface is coupled to the ultrasonic detection system by a board-to-board connection.

16. The method of claim 13, wherein the ultrasonic data is held in a DDR (Double Data Rate DRAM) buffer.

17. The method of claim 16, wherein the ultrasonic data is transferred to the USB interface through a DMA (Direct Memory Access) channel.

18. The method of claim 17, wherein the acquisition interface, the access control of the DDR buffer, or the establishment of the DMA channel are implemented based on FPGA.

19. The method of claim 13, wherein the ultrasonic data are held in two buffers used alternatively, and
one of the two buffers starts to receive and hold the ultrasonic data obtained from the acquisition interface, while the other buffer is filled up and starts transferring the ultrasonic data therein.

20. An apparatus for high-speed ultrasonic data acquisition, which is arranged within a casing of an ultrasonic detection system and used for transferring ultrasonic data from the ultrasonic detection system to a host computer for further processing, the apparatus comprising:
an acquisition interface, coupled to the ultrasonic detection system by a board-to-board connection, for obtaining ultrasonic data from the ultrasonic detection system;
a DDR buffer for holding the ultrasonic data obtained by the acquisition interface;
a DDR controller coupled to the acquisition interface and the DDR buffer, for controlling access to the DDR buffer;
a DMA channel unit, coupled to the DDR controller, for transferring the ultrasonic data from the DDR buffer in a DMA mode;
a high-speed USB controller, coupled to the DMA channel unit, for transferring the ultrasonic data from the DMA channel unit to the host computer via a USB interface;
a processor, coupled to the DDR controller and the high-speed USB controller, for controlling the transfer of the ultrasonic data based on a command received from the host computer via the USB interface;
wherein one or more of the acquisition interface, the DDR controller, the DMA channel unit and the processor are based on FPGA.
